(19) United States
(12) Patent Application Publication
(10) Pub. No.: US 2012/0111836 A1
(43) Pub. Date: May 10, 2012

(54) Process for Treating Staves for the Manufacture of Barrels, Tool for Implementing Same, and Stave Obtained by This Process

(75) Inventor: Jean-Charles Vicard, Cognac (FR)

(73) Assignee: GROUPE VICARD, Cognac (FR)

(21) Appl. No.: 13/117,422

(22) Filed: May 27, 2011

(30) Foreign Application Priority Data
Nov. 8, 2010 (EP) 10306222.0

(51) Int. Cl. B27H 3/00; B27H 3/02

(52) U.S. Cl. 217/88; 147/35.5

(57) ABSTRACT

Process for treating staves for the manufacture of barrels comprising scarifying in the mass of the wood, by any appropriate mechanical means, shafts that allow the escape of gases and water vapor emerging from the wood during the firing process. The shafts comprise holes or incisions formed at regular intervals on the surface of the inner side of the staves.

### CROSS REFERENCE TO RELATED APPLICATION

This application claims priority to European patent application number 10306222.0, publication number EP 2 319 667 A1, filed on Nov. 8, 2010 and incorporated herein in its entirety by reference.

### TECHNICAL FIELD

The present invention relates to a process for treating staves for the manufacture of barrels, a tool for implementing this process and the new product obtained by this process.

### BACKGROUND

As used herein, a “stave” refers to cask wood machined on four sides, a barrel being made from the assembly of such staves, and “cask wood” refers to a piece of unrefined oak split in the direction of the medullary rays.

A known technique is to perform, after the assembly of staves, a heating process wherein the inner wall of the barrel during manufacturing is heated to temperatures on the order of 300 to 400° C. This operation is also called firing or toasting.

Although staves have been, before their implementation, dried in the open air for several years, then run through a dehumidifying cell, there are still water molecules trapped between the wood fibers. When heated, this residual moisture will turn into an emission of gas and water vapor, causing the appearance of blisters on the inside of some staves, which can, depending on the extent of the blisters, lead to the need to replace some staves, which considerably complicates the manufacture of the barrel.

### SUMMARY

The present invention has the objective of providing a process for eliminating this blistering, and the means for implementing this process.

The process disclosed herein consists of creating in the mass of wood, by any suitable mechanical means, shafts that allow the escape of gases and water vapor which come out of the wood during the firing process.

According to a particular embodiment, a plurality of holes is created at regular intervals on the surface of the inside of each stave by means of spikes. In one particular example, scarring of the wood is carried out by making a plurality of incisions on its surface. The holes or incisions can have a depth between 0.2 and 2 cm. The holes or incisions can have a depth of 1 cm.

Also disclosed herein are embodiments of a tool for implementing the process, which comprises a plurality of spikes arranged at regular intervals arranged on a plate carried by a press. The tool can be constituted of a cylindrical roller wherein the surface thereof is provided with a plurality of spikes about 1 cm long arranged at regular intervals. The spikes can be triangular blades about 1 cm long. The rotary tool can be positioned at the end of the machining tool by which the cask wood is converted into staves.

The invention also relates to, as a novel product, barrel staves wherein the inner wall thereof is provided with scarifications.

### BRIEF DESCRIPTION OF THE DRAWINGS

The embodiments will be better understood, and other objectives, details, characteristics and advantages thereof will emerge more clearly from the following description of a particular embodiment of the invention, given solely as an illustration and not a limitation, with reference to the attached drawings. In the drawings:

FIG. 1 is a perspective view of a tool for the implementation of the invention;

FIG. 2 is a perspective view illustrating running a stave through the tool of FIG. 1;

FIG. 3 shows the inner side of a stave before scarification;

FIG. 4 shows the same inner side after scarification;

FIG. 5 shows an unscarified stave after heating;

FIG. 6 shows a scarified stave after heating; and

FIG. 7 is a schematic representation of a machine that can be used to implement a process of machining and scarifying staves.

### DETAILED DESCRIPTION

The scarification according to the invention can be accomplished by any known mechanical means such as puncturing or incision. The puncturing may be achieved by a plate provided with a plurality of spikes, the plate being subjected to the action of a press such that the spikes penetrate into the wood.

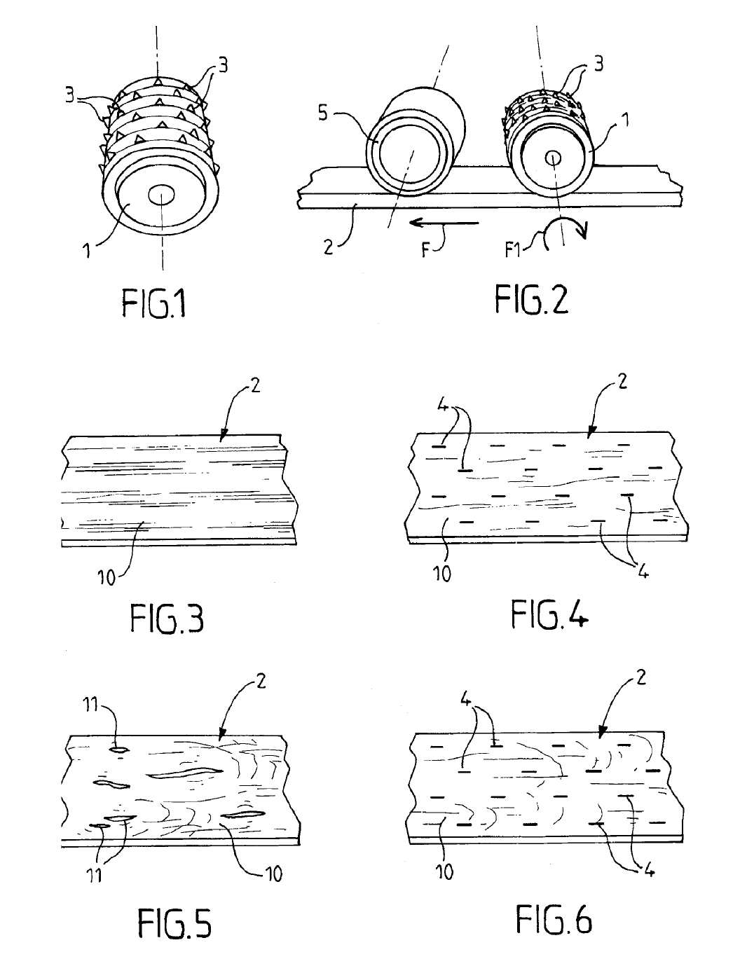

A tool shown in FIGS. 1 and 2 is disclosed for use in the scarification.

The tool 1 is a rotary tool which is placed at the end of the machining tool by which the staves 2 are made, which tool performs machining on four sides of the cask wood.

As shown in FIGS. 1 and 2, the tool 1 is a cylindrical roller wherein the wall thereof is provided with a plurality of blades 3, the blades being triangular and of a length of about 1 cm.

The stave 2 is driven by rollers such as the roller 5 so as to move along the arrow F, thereby forcing it to pass under the tool 1, wherein the knives 3 thereof penetrate into the wood, causing incisions 4 at regularly spaced intervals, the tool 1 being driven to rotate along arrow F1.

These incisions, when blades such as the blades 3 are used, or the holes, when spikes are used, should have a depth between 0.2 and 2 cm, in particular 1 cm, but should obviously not pass through the entire thickness of the stave, which is 3 cm.

FIG. 3 shows the inner surface of a stave 2 before scarification. The medullary rays 10 of the wood are shown schematically in FIG. 3 only.

FIG. 4 shows the inner surface of the same stave 2 after scarification: the incisions 4 made on this surface are visible.

FIG. 5 shows the inner surface of a stave 2 having undergone the heating process without first having been scarified by the process according to the present invention.

FIG. 6 shows the surface of a stave having been scarified by the process according to the invention.

A comparison of FIGS. 5 and 6 shows the very beneficial result obtained by the scarification process according to the invention: without applying the scarification process, blisters 11 have appeared after heating, whereas there are no blisters on the surface of the stave having been treated according to the scarification process.

According to some embodiments, the density of the incisions or perforations may be between 500 and 2500 per m², preferably between 1000 and 1500 per m².

According to the particular embodiment shown in FIG. 4, each line of perforation is formed by staggering from one to the next, such that the layout of the perforations is made in the shape of a diamond. As a quantitative example, a density of about 1200 perforations per m² is obtained by making such perforations spaced every 36 mm in the lengthwise direction of the path of the piece of wood and spaced 22.5 mm in the widthwise direction, the diamonds in this case presenting sides of about 26 mm. These dimensions are given with reference to the centers of the perforations.

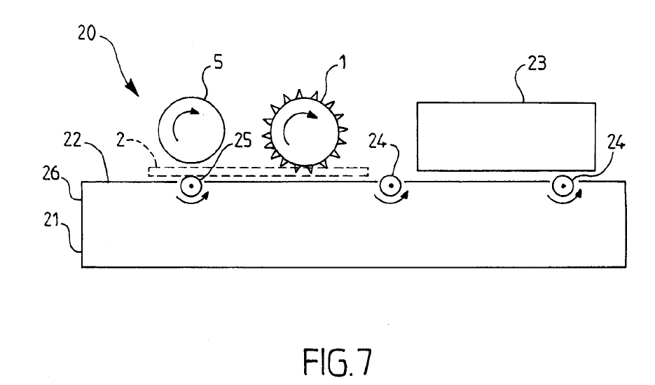

Referring to FIG. 7, a machine tool 20 for the manufacture of cooperage staves is schematically represented. Elements identical to those of the preceding figures bear the same reference number. The machine comprises a frame 21 in one or more parts that defines a substantially horizontal support surface 22 for the path of the staves. A machining tool 23, for example as a planer/molder with four faces, and the scarification tool 1 described with reference to FIG. 2 are arranged in succession along the support surface 22. Such an arrangement makes it possible to continuously proceed with the machining steps and scarification of the stave by limiting the transfer time of the staves and manual operation. Preferably, driving means are provided to automatically move the staves along the support surface 22, such as the rollers 24 at the level of the machining tool 23 and the rollers 5 and 25 at the level of the scarification tool. Thus, the machined and scarified stave 2 can be retrieved by an operator at the level of the end 26 of the frame.

Alternatively, other tools for treating or conditioning the staves could further be provided along the support surface 22.

Although the invention has been described in association with a particular embodiment, it is quite evident that it is in no way limited thereto and that it comprises any technical equivalent of the means described, as well as combinations thereof if they are within the scope of the invention.

The use of the verb “comprise,” “have” or “include” and the conjugated forms thereof does not preclude the presence of elements or steps other than those recited in a claim. The use of the indefinite article “a” for an element does not, unless otherwise stated, preclude the presence of a plurality of such elements.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A process for treating staves for the manufacture of barrels comprising:
scarifying a mass of wood of the stave, by a mechanical means, with shafts configured to allow escape of gases and water vapor emerging from the wood during a firing process, the shafts comprising holes or incisions formed at regular intervals on a surface of an inner side of the staves.

2. The process according to claim 1, wherein the mechanical means comprises spikes configured to create a plurality of holes at regular intervals on the surface of the inside of each stave.

3. The process according to claim 1, wherein the scarifying of the wood is performed by forming on the surface a plurality of incisions with blades.

4. The process according to claim 1, wherein the holes or incisions have a depth between 0.2 and 2 cm.

5. The process according to claim 4, wherein the holes or incisions have a depth of 1 cm.

6. The process according to claim 1, further comprising:
prior to scarifying, converting cask wood into staves with a machining tool, wherein the mechanical means is positioned at an end of the machining tool.

7. A tool for implementing the process according to claim 1 comprising:
a plurality of spikes or blades arranged at regular intervals on a plate carried by a press.

8. A tool for implementing the process according to claim 1 comprising:
a cylindrical roller having a surface provided with a plurality of spikes or blades arranged at regular intervals.

9. The tool according to claim 7, wherein each of the plurality of spikes or blades are triangular.

10. The tool according to claim 7, wherein each of the plurality of spikes or blades are about 1 cm long.

11. The tool according to claim 8, wherein each of the plurality of spikes or blades are triangular.

12. The tool according to claim 8, wherein each of the plurality of spikes or blades are about 1 cm long.

13. A barrel stave comprising an inner surface having scars formed of holes or incisions at regular intervals.
